(19) United States
(12) Patent Application Publication
(10) Pub. No.: US 2025/0028218 A1
(43) Pub. Date: Jan. 23, 2025

(54) OPTOELECTRONIC EMITTER HAVING A PHASE-CONTROLLED ANTENNA ARRAY COMPRISING OPTICAL ANTENNAS SUITABLE FOR EMITTING LIGHT RADIATION ACCORDING TO A PREDEFINED EMISSION PROFILE AND IN A PREDEFINED DIRECTION

(71) Applicant: COMMISSARIAT A L'ENERGIE ATOMIQUE ET AUX ENERGIES ALTERNATIVES, Paris (FR)

(72) Inventors: Sylvain GUERBER, Grenoble Cedex 09 (FR); Daivid FOWLER, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/714,820

(22) PCT Filed: Nov. 29, 2022
(86) PCT No.: PCT/EP2022/083579

§ 371 Date: Jun. 18, 2024

(30) Foreign Application Priority Data
Dec. 1, 2021 (FR) 2112786

(51) Int. Cl. G02F 1/29; G02F 1/313

(52) U.S. Cl. CPC G02F 1/292; G02F 1/313

(57) ABSTRACT

An optical phased array transmitter comprising a plurality of optical antennas each formed by a waveguide and by a diffraction grating located above and at a distance from the waveguide along a vertical axis orthogonal to a main plane. The waveguide there has a width that varies longitudinally according to a first predefined function, and the diffraction grating has an arrangement pitch of periodic structures that varies longitudinally according to a second predefined function. The first and second predefined functions are predefined such that a near-field emission profile of the light radiation emitted by the optical antenna is equal to a predefined target emission profile, and that a local emission angle of the emitted light radiation is equal to a predefined, longitudinally constant target emission angle.

### TECHNICAL FIELD

The field of the invention is that of optical phased array transmitters preferably produced on a photonics-on-silicon photonic chip. The invention is applicable in particular in the field of LIDAR (Light Detection and Ranging).

### PRIOR ART

Optical phased array (OPA) transmitters are optoelectronic devices for emitting monochromatic light radiation in a directional manner in free space. They are applicable in particular in the field of light detection and ranging (LIDAR), but also in the field of free-space optical communications, holographic screens and medical imaging.

FIG. 1A schematically illustrates the operating principle of such an optoelectronic transmitter 1. A laser source 2 transmits an optical signal, which is distributed by a power splitter 3 into arms 4 of the optoelectronic transmitter 1. Each arm 4 comprises a phase shifter 6 and an elementary transmitter 7, also called an optical antenna. Each optical antenna 7 transmits an optical signal in free space, for example by diffraction, the optical signals then combining through interference so as to form light radiation. Said light radiation has a far-field emission pattern that is determined in particular by the relative phase Δφ applied by the phase shifters 6 to the optical signals propagating in the arms 4.

Such optoelectronic transmitters may be produced using integrated photonics, that is to say its various optical components (waveguides, power splitter, optical antennas, etc.) are produced on and from one and the same photonic chip. In this respect, FIG. 1B schematically and partially illustrates one example of such an optoelectronic transmitter 1 described in the article by Hulme et al. entitled Fully integrated hybrid silicon two dimensional beam scanner, Opt. Express 23 (5), 5861-5874 (2015). This optoelectronic transmitter 1 comprises a laser source 2, here an III-V laser source, and is produced on one and the same photonic chip. It therefore comprises a semiconductor laser source 2, the power splitter 3, waveguides 5, the phase shifters 6 and the optical antennas 7 located in the arms 4. In this example, the laser source 2 is produced by transferring an III-V material onto the (SOI) photonic chip and then structuring said material so as to form the gain medium.

Moreover, in order to form relatively non-divergent light radiation in the far field, it is necessary in particular for each optical antenna to transmit over a great length, for example over one to several hundred microns. One solution therefore consists in reducing the extraction rate of the optical antennas, for example by producing the diffraction grating not in the waveguide but at a distance therefrom, for example above it, such that only the evanescent part of the optical mode is sensitive to periodic structures of the diffraction grating.

In this regard, the Article by Han et al. entitled Highly directional waveguide grating antenna for optical phased array, Current Applied Physics, 18 (2018) 824-828describes one example of an optical antenna in which the diffraction grating is located above and at a distance from a silicon waveguide, and is formed in the upper face of the cladding covering the waveguide. The values of the dimensional parameters of the waveguide and of the diffraction grating remain constant along the optical antenna, and are chosen in particular so as to limit optical losses associated with parasitic reflections and to optimize the directivity of the optical antenna.

Moreover, the article by Wang et al. entitled Silicon nitride assisted 1×64 optical phased array based on a SOI platform, Opt. Express 29(7), 10513-10517 (2021) describes another example of an optical antenna in which the diffraction grating is located above and at a distance from a silicon waveguide, and formed here by periodic pads made of a silicon nitride and encapsulated in a layer made of a silicon oxide. In this case too, the values of the dimensional parameters of the waveguide and of the diffraction grating remain constant along the optical antenna.

However, the optical mode circulating in the waveguide of the optical antenna has an optical power P(x) that decreases exponentially along the longitudinal axis as a portion is extracted therefrom. Therefore, for an extraction rate αᵣ(x) of the diffraction grating that remains longitudinally constant and equal to do, the near-field emission profile S(x) of the light radiation emitted by the optical antenna also exhibits an exponential decrease along the longitudinal axis, according to the relationship S(x)˜α0ΔP(x), this possibly resulting in degradation of the far-field emission pattern of the light radiation.

Therefore, in order to avoid this reduction in the effective transmission length of the optical antenna, one solution could be to longitudinally modulate the extraction rate and therefore to vary the values of the dimensional parameters of the diffraction grating along the longitudinal axis. However, this would result in the production of a diffraction grating having particularly small periodic structure dimensions, for example smaller than 100 nm, which are therefore barely compatible or not compatible with the conventional technologies usually used in fabrication processes, for example in photonics-on-silicon.

### DESCRIPTION OF THE INVENTION

The invention aims to at least partially remedy the drawbacks of the prior art, and more particularly to propose an optical phased array transmitter whose far-field light radiation is relatively non-divergent and has a predefined, for example constant or Gaussian, emission pattern. For this purpose, each optical antenna is designed to emit light radiation with a desired, for example constant or Gaussian, near-field emission profile S_{c}(x) and oriented at a predefined emission angle θ_{c} that is longitudinally constant, without it being necessary to produce diffraction gratings with excessively small dimensions.

To this end, an object of the invention is a process for fabricating an optical phased array transmitter, which comprises: a splitter, intended to be coupled to a laser source; a plurality of waveguides, coupled to the splitter and extending along a longitudinal axis in a main plane, forming arms of the optoelectronic transmitter; and a plurality of phase shifters and optical antennas, arranged in the arms, each optical antenna being formed by the corresponding waveguide and by a diffraction grating located above and at a distance from the waveguide along a vertical axis orthogonal to the main plane.

The process comprises the following steps:
defining a target near-field emission profile S_{c}(x) and a target emission angle θ_{c} for light radiation emitted by each optical antenna, and a structural configuration Cs_{ref}of said optical antennas, comprising: values of physical parameters Pp_{wg} of the waveguides defining optical properties of transmission of an optical mode from the laser source; and values of physical parameters Ppᵣ of the diffraction gratings defining optical properties of diffraction of the optical mode;
determining a relationship Λᵣ=f(w_{c}) expressing a change in the pitch αᵣ of periodic structures of the diffraction grating as a function of a width w_{c} of the waveguide, such that, taking into account said structural configuration CS_{ref}, an emission angle θ(x) of the light radiation emitted by the optical antenna is equal to said target emission angle θ_{c};
determining a relationship Λᵣ=g(w_{c}) expressing a change in an extraction rate αᵣ of the diffraction grating as a function of the width we of the waveguide, taking into account said relationship Λᵣ=f(w_{c}) and said structural configuration Cs_{ref};
determining a longitudinal variation w_{c}(x) in the width w. of the waveguide and deducing a corresponding longitudinal variation Λᵣ(x) in the pitch Λᵣ of the diffraction grating based on said relationship Λᵣ=f(w_{c}), such that, taking into account said relationship αᵣ=g(W_{c}) and said structural configuration Cs_{ref}, a near-field emission profile S(x) of the light radiation emitted by the optical antenna is equal to said target emission profile S_{c}(x);
fabricating the optoelectronic transmitter whose optical antennas have the reference structural configuration Cs_{ref}, supplemented by said longitudinal variation w_{c}x) in the width w. of the waveguide and said longitudinal variation Λᵣ(x) in the pitch Λᵣ of the diffraction grating.

Some preferred but non-limiting aspects of this optoelectronic transmitter are as follows.

The steps of determining the relationships Λᵣ=f(w_{c}) and αᵣ=g(w_{c}) may be carried out for a range of widths w_{c} ranging from a predefined minimum value w_{c,out} and a predefined maximum value w_{c,in}.

The step of determining the longitudinal variation w_{c}(x) may comprise the following operations: defining a power function with an exponent n representative of a longitudinal variation w_{c}=p(m)(x) in the width wo between the predefined maximum value Wc.out and the predefined minimum value w_{c,in}; determining, for multiple values n₍ₘ₎ of the exponent n, a longitudinal variation w_{c}=p₍ₘ₎(x) in the width w_{c} of the waveguide and deducing a corresponding longitudinal variation Λᵣ=q₍ₘ₎(x) in the pitch Λᵣ of the diffraction grating; and determining a longitudinal variation ar (m) (x) in the corresponding extraction rate αᵣ based on said relationship αᵣ=g(w_{c}), and then a corresponding emission profile S₍ₘ₎(x); and then determining an optimum value n₍ₘₒₚₜ₎ from among the values n₍ₘ₎ of the exponent n for which the emission profile S₍ₘₒₚₜ₎(x) exhibits a minimum deviation from the target emission profile S_{c}(x).

The power function may be w_{c}(x)=w_{c,in}+(x/La)ⁿ×(w_{c,in}−w_{c,out}), where La is the total length of the part of the optical antenna that exhibits the longitudinal variations in the width wo of the waveguide and the pitch Λᵣ of the diffraction grating.

The invention also relates to an optical phased array transmitter, comprising: a splitter, intended to be coupled to a laser source; a plurality of waveguides coupled to the splitter and extending along a longitudinal axis in a main plane, forming arms of the optoelectronic transmitter; a plurality of phase shifters and optical antennas arranged in the arms, each optical antenna being formed by the corresponding waveguide and by a diffraction grating located above and at a distance from the waveguide along a vertical axis orthogonal to the main plane.

According to the invention, over at least part of the length of each optical antenna: the waveguide has a width W_{c}=p(x) that varies longitudinally according to a predefined function p; the diffraction grating has an arrangement pitch Λᵣ=q(x) of periodic structures that varies longitudinally according to a predefined function q; the functions p and q being predefined such that a near-field emission profile S(x) of the light radiation emitted by the optical antenna is equal to a predefined target emission profile S_{c}(x), and that a local emission angle θ(x) of the emitted light radiation is equal to a predefined, longitudinally constant target emission angle θc.

The function p regarding longitudinal variation in the width We may be a decreasing function, and the function q regarding longitudinal variation in the pitch Λᵣ may be an increasing function.

Each of the periodic structures may extend facing all of the waveguides of the optical antennas.

The waveguides and the diffraction gratings may be produced in a silicon-based photonic chip.

The periodic structures of the diffraction gratings may have a filling factor, defined as the ratio between a transverse dimension of the periodic structures along the longitudinal axis and the pitch Λᵣ, that is constant along the longitudinal axis of the optical antennas.

### BRIEF DESCRIPTION OF THE DRAWINGS

Other aspects, aims, advantages and features of the invention will become more clearly apparent on reading the following detailed description of preferred embodiments thereof, which is given by way of non-limiting example and with reference to the appended drawings, in which:

FIG. 1A, already described, is a schematic and partial view of an optical phased array transmitter according to one example from the prior art;

FIG. 1B, already described, is a schematic and partial plan view of such an optoelectronic transmitter produced using integrated photonics according to one example of the prior art;

FIGS. 2A and 2B are schematic and partial views, in longitudinal section and in plan view, of an optical antenna of an optoelectronic transmitter according to one embodiment, where this comprises an apodized part exhibiting longitudinal variations in the width of the waveguide and the pitch of the diffraction grating;

FIG. 2C is a schematic and partial plan view of an optical antenna of an optoelectronic transmitter according to one alternative embodiment;

FIG. 3 is a flowchart illustrating steps of a process for fabricating an optoelectronic transmitter similar to that of FIG. 2B;

FIG. 4A illustrates one example of a relationship Λᵣ=f(w_{c}) expressing a change in the pitch Λᵣ of the diffraction grating as a function of the width w_{c} of the waveguide, such that the near-field emission angle θ(x) of the light radiation emitted by the optical antenna is equal to a target value θ_{c};

FIG. 4B illustrates one example of a relationship αᵣ=f(w_{c}) expressing a change in the extraction rate ar of the diffraction grating as a function of the width wo of the waveguide, such that the near-field emission angle θ(x) of the light radiation emitted by the optical antenna is equal to a target value θ_{c}, and that the near-field emission profile S(x) is equal to the target emission profile S_{c}(x);

FIG. 4C illustrates one example of an emission profile S(x) of emitted light radiation for an optical antenna comprising an apodized part followed by a non-apodized part, and the target emission profile S_{c}(x).

### DETAILED DESCRIPTION OF PARTICULAR EMBODIMENTS

In the figures and in the remainder of the description, the same references represent identical or similar elements. In addition, the various elements are not shown to scale so as to make the figures clearer. Moreover, the various embodiments and variants are not mutually exclusive and may be combined with one another. Unless otherwise indicated, the terms “substantially”, “around”, “of the order of” mean to within 10%, and preferably to within 5%. In addition, the terms “between . . . and . . . ” and the like mean that the bounds are included, unless otherwise indicated.

The invention relates to an optical phased array transmitter comprising a plurality of optical antennas each formed by a waveguide and by a diffraction grating located above and at a distance from the waveguide. The optical antennas are preferably produced on a photonics-on-silicon photonic chip. The optoelectronic transmitter is designed to emit light radiation having a predefined, for example constant or Gaussian, far-field emission pattern, oriented at a predefined emission angle, and exhibiting relatively little divergence at least in a vertical plane parallel to the optical antennas.

A far-field emission pattern is the angular distribution of the intensity of the far-field light radiation emitted by the optoelectronic transmitter, about a main axis oriented along the emission angle. The far field (or Fraunhofer zone) corresponds to a distance D greater than the ratio between the square of a major dimension of the optical antenna (here its length Loot along the longitudinal axis) and the wavelength λ of the light radiation, and more precisely: D>2Lₜₒₜ²/λ.

In order for the optoelectronic transmitter to emit light radiation whose far-field emission pattern and emission angle correspond to those expected, the optical antennas are designed to emit light radiation with a near-field emission profile and emission angle that are equal to a predefined target profile and angle. In the remainder of the description, reference will be made to a far-field emission pattern of the optoelectronic transmitter, and to a near-field emission profile S(x) (or emission pattern) of the optical antennas, where x is the longitudinal abscissa associated with the optical antenna. Moreover, θ(x) is also used to denote the local emission angle of the light radiation emitted by the optical antenna with respect to a vertical axis Z.

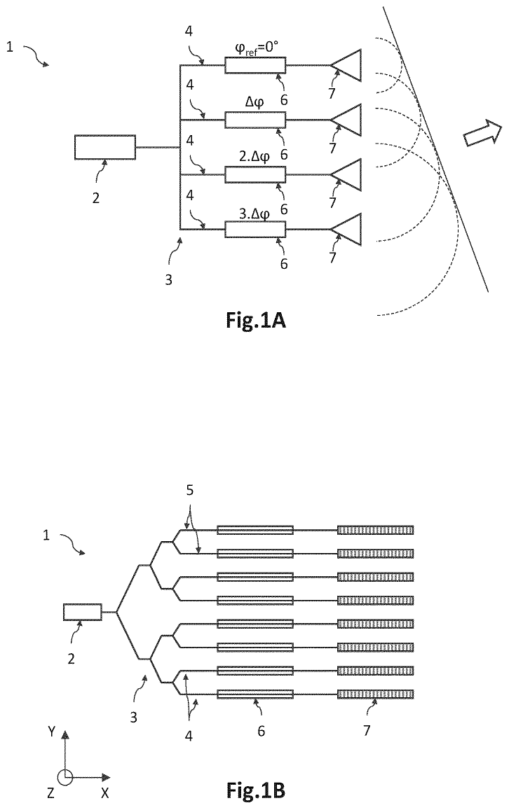

Reference is made again to FIG. 1B, described briefly above, to now describe in more detail the basic optical components of an optoelectronic transmitter 1 according to one embodiment.

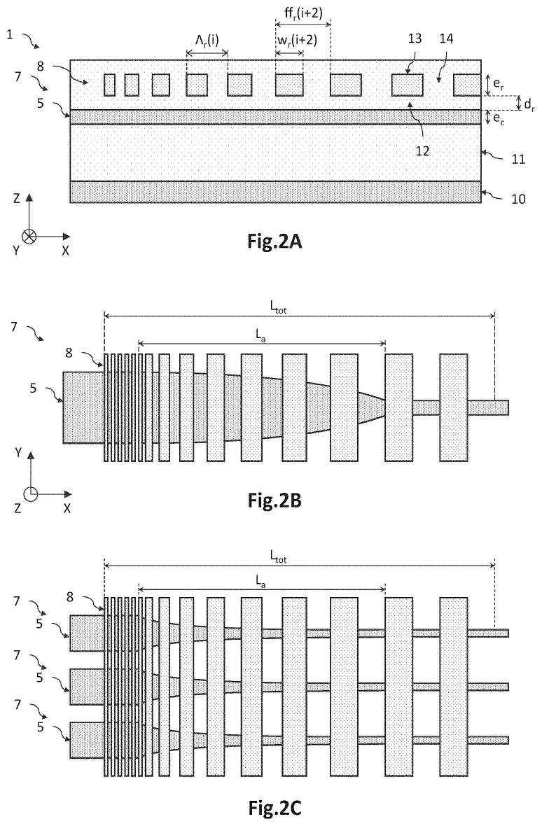

Here and for the remainder of the description, a direct orthonormal coordinate system XYZ is defined, where the plane XY is parallel to the plane of the photonic chip, the axis X being oriented along the longitudinal axis of the optical antennas 7, and where the axis Z is oriented toward the free space into which the light radiation is emitted by the optoelectronic transmitter 1. The terms “lower” and “upper” relate to a distance from a carrier substrate 10 (cf. FIG. 2A) in the direction +Z.

In this embodiment, the optoelectronic transmitter 1 is integrated on a photonic chip, for example in the context of what is known as photonics-on-silicon technology. The photonic chip, also called a photonic integrated circuit (PIC), comprises a carrier substrate 10 from which it is possible to produce active photonic components (modulators, diodes, etc.) and passive photonic components (waveguides, multiplexers or demultiplexers, etc.) that are optically coupled to one another. In the context of photonics-on-silicon, the carrier substrate 10 and the photonic components are made from silicon. The carrier substrate 10, illustrated in FIG. 2A, may thus be an SOI (silicon on insulator) substrate. Thus, in this example, the waveguides 5 are made of silicon.

However, many other technological platforms may be used depending on the intended applications and the wavelength of the light radiation. The waveguides 5 may thus for example be made of silicon nitride (SIN), aluminum nitride (AlN), doped silica, etc.

The optoelectronic transmitter 1 comprises a laser source 2 designed to transmit a pulsed or continuous monochromatic optical signal of wavelength λ. By way of illustration, the wavelength may be equal to 1550 nm. The laser source 2 may be wavelength-tunable, in particular in order to modify the emission angle θ formed by the light radiation emitted by the optical antennas 7 with respect to the vertical axis Z in the plane ZX. The laser source 2 may be a hybrid source formed by a gain medium made from an III/V compound and bonded to the surface of the photonic chip. Optical reflectors such as Bragg mirrors may thus be produced in an integrated waveguide coupled to the gain medium. As a variant, the photonic chip might not comprise the laser source 2, the latter then being remote and therefore not joined to the surface of the photonic chip. It may then be coupled to an integrated waveguide of the photonic chip, in particular by a grating coupler.

A power splitter 3 is coupled to the output of the laser source 2. It thus comprises one input and a plurality of outputs each coupled to a waveguide of the optoelectronic transmitter 1. The number of waveguides 5 corresponds to the number of arms 4 of the optoelectronic transmitter 1. In this example, the power splitter 3 is formed by multiple MMI (Multimode Interferometer) splitters arranged in cascade, but other types of optical component may be used.

The optoelectronic transmitter 1 comprises a plurality of waveguides 5 that

extend between a first end coupled to one of the outputs of the power splitter 3 and an opposite second end. Each waveguide 5 is therefore designed to receive an optical signal from the power splitter 3 and to allow this optical signal to propagate to an optical antenna 7.

The optoelectronic transmitter 1 also comprises a plurality of phase shifters 6

arranged in the arms 4. More precisely, a waveguide 5 is coupled to at least one phase shifter designed to modify the phase of the optical signal circulating in the waveguide 5 under consideration, and thus to generate a phase difference Δφ, or relative phase, between the optical modes circulating in the adjacent waveguides 5. The phase shifters 6 are arranged between the power splitter 3 and the optical antennas 7. Each waveguide 5 may be equipped with a phase shifter, or only some of the waveguides 5, such as for example one waveguide 5 out of two. Moreover, a reference waveguide 5 might not comprise a phase shifter.

The phase shifters 6 may be electro-refractive phase shifters or thermo-optical phase shifters. In both cases, the phase is modified by modifying the refractive index n. of the waveguide 5 under consideration. The refractive index may be modified in this way by modifying the density of free carriers in the case of the electro-refractive phase shifter, or by modifying the applied temperature in the case of the thermo-optical phase shifter.

The phase shifters 6 are designed to apply a predefined relative phase value Δφ

to the optical modes propagating in the waveguides 5, so as to obtain a determined non-zero angle Φ of the main emission axis with respect to the vertical axis Z in the plane YZ (orthogonal to the longitudinal axis X of the optical antennas 7). However, the relative phase Δφ might not be identical among the waveguides 5, either in order to obtain a different far-field pattern or to take into account and compensate for any phase errors. These phase errors may result from degradation over time of certain components of the optoelectronic transmitter 1, non-uniformities in the fabrication process, non-zero tolerances of the fabrication process, the impact of the environment of the optoelectronic transmitter 1 (for example potential effect of the packaging elements covering the elementary transmitters).

The phase shifters 6 are preferably connected to a control module (not shown). Depending on the control signals sent by the control module, the phase shifters 6 are able to generate a predetermined relative phase Δφ in the optical signals circulating in the various waveguides 5. One example of such a control module is described in the article by Hulme et al. entitled Fully integrated hybrid silicon two dimensional beam scanner, Opt. Express 23 (5), 5861-5874 (2015), or in document WO2021/130149A1.

The optoelectronic transmitter 1 comprises a plurality of optical antennas 7 arranged downstream of the phase shifters 6, at the rate of one optical antenna 7 per arm 4. The relative phase Δφ between the optical signals transmitted by the optical antennas 7 determines in particular the value of the angle Φ formed by the main emission axis of the light beam in the far field with respect to the vertical axis Z in the plane YZ of the optoelectronic transmitter 1.

FIGS. 2A and 2B are partial and schematic views, in longitudinal section (FIG. 2A) and in plan view (FIG. 2B), of one of the optical antennas 7 according to one embodiment. Each optical antenna 7 is formed by the waveguide 5 and a diffraction grating 8, which is located above and at a distance from the waveguide 5 along the vertical axis Z.

According to the invention, over at least part of the length of the optical antenna 7, the waveguide 5 exhibits a longitudinal variation w_{c}=p(x) in its width we according to a predefined function p, and the diffraction grating 8 exhibits a longitudinal variation Λᵣ=q (x) in the arrangement pitch Λᵣ of the periodic structures according to a predefined function q.

The functions p and q are predefined such that the optical antenna 7 emits light radiation whose near-field emission profile S(x) is equal to a predefined target emission profile S_{c}(x), and which is oriented at a local emission angle θ(x) with respect to the vertical axis Z (and along the direction +Z) that is equal to a predefined target value θ_{c} that is longitudinally constant.

This region of the optical antenna 7 that comprises these longitudinal variations w_{c}(x) and Λᵣ(x) is a part of the optical antenna 7 that is said to be apodized. Said antenna may comprise, upstream and/or downstream, a non-apodized part where the width w_{c} of the waveguide 5 and the pitch Λᵣ of the diffraction grating 8 remain constant. Moreover, Lₜₒₜ is used to denote the total length of the optical antenna 7, and Lₐ is used to denote the length of the apodized part.

The waveguide 5 is defined by physical parameters Pp_{wg} that are representative of the properties of transmission of the optical mode by the waveguide 5, and which are therefore also representative of the spatial distribution of the intensity of the optical mode in the transverse plane YZ. These physical parameters Pp_{wg} here are the refractive index n_{c} of the waveguide 5 and the refractive index n_{g} of the cladding, and the dimensional parameters of the waveguide 5 such as the thickness e_{c} along the vertical axis Z, and its width w_{c} along the axis Y.

The waveguide 5 and the diffraction grating 8 are produced here in a photonic chip, here using photonics-on-silicon technology. Said chip is formed by a carrier substrate 10, here made of silicon, a lower buried oxide (BOX) layer 11 that contributes to forming the cladding of the waveguide, the waveguide 5 produced in a silicon layer, a spacer layer 12 made of a silicon oxide, and here periodic pads 13 made for example of a silicon nitride and encapsulated in a filling layer 14 made of a silicon oxide.

Preferably, the refractive index n_{c} of the waveguide 5 (that is to say of the core of the waveguide 5) and its thickness e_{c} remain constant over the entire length Lₜₒₜ of the optical antenna 7. On the other hand, the waveguide 5, in the apodized part, exhibits a longitudinal variation w_{c}(x) in its width w_{c} between an upstream value W_{c,in} and a downstream value W_{c,out}. The width w_{c} thus varies longitudinally according to a predefined function p, such that w_{c}=p(x). By way of example, in the case of a Gaussian target profile S_{c}(x), the function p is a decreasing monotonic function.

This longitudinal variation w_{c}(x) in the width w_{c} of the waveguide 5 results in a longitudinal variation n_{eff}(x) in the effective index n_{eff} of the optical mode circulating in the waveguide 5, insofar as the effective index of an optical mode depends on the transverse dimensions of the waveguide 5. In general, the effective index n_{eff} associated with an optical mode supported by a waveguide is defined as the product of the propagation constant β and λ/2π. The propagation constant β depends on the wavelength λ of the optical mode, and on the properties of the waveguide (refractive index n_{c} and n_{g}, and transverse dimensions θ_{c} and w_{c}). The effective index n_{eff} of the optical mode corresponds, in a certain way, to the refractive index of the waveguide “seen” by the optical mode. It is usually between the refractive index n_{c} of the waveguide and the refractive index ng of the cladding.

The longitudinal variation w_{c}(x) in the width wo of the waveguide 5 thus causes a longitudinal variation n_{eff}(x) in the effective index n_{eff} and therefore a modification of the spatial distribution of the optical mode along the longitudinal axis X, thereby contributing to determining the local influence of the diffraction grating 8 on the evanescent part of the optical mode, in terms of both extraction rate and emission angle. Indeed, in this respect, it should be recalled that the emission angle θ(x) of the light radiation by a diffraction grating 8 may be determined by the following relationship:

$$sin θ ( x ) = \frac{{n}_{eff} ( x ) + m \frac{λ}{Λ}}{{n}_{c}}$$

where m is the diffraction order.

It therefore appears that, in order to keep the emission angle θ(x) equal to the target value θ_{c} and constant along the longitudinal axis X, it is important also to define a longitudinal variation Λᵣ(x) in the pitch Λᵣ of the diffraction grating 8.

The optical antenna 7 therefore comprises a diffraction grating 8 that is not produced directly in the waveguide 5, but is located above and at a distance therefrom along the vertical axis Z. It is therefore spaced therefrom by a non-zero distance dᵣ defined as the distance between the upper surface of the waveguide 5 and the lower surface of the periodic structures of the diffraction grating 8. It should be noted that this distance dᵣ may be zero. In any event, the diffraction grating 8 is not produced in the waveguide 5, for example by localized partial etching thereof.

The diffraction grating 8 is formed by periodic structures arranged along the waveguide 5 along the longitudinal axis X. Various types of structures are possible. In this example in which the diffraction grating 8 is of the same type as that in the abovementioned Wang 2021 article, the periodic structures are formed by pads 13 of a material with a high refractive index, here a silicon nitride, separated from one another by a through-notch filled with a material with a low refractive index (identical to that of the cladding surrounding the waveguide 5, and here made of a silicon oxide). The notches are through-notches here, but might not be. As a variant, the diffraction grating 8 could be of the same type as that in the abovementioned Han 2018 article, that is to say be formed of notches made in the upper face of the cladding layer of the waveguide 5.

The diffraction grating 8 is defined by physical parameters Ppᵣ that are representative of the diffraction (and therefore the extraction) of the evanescent part of the optical mode, namely here the spacing dᵣ of the diffraction grating 8 with respect to the waveguide 5, the refractive indices of the structures, namely here nᵣ for the silicon nitride pads 13 and nₘᵣ for the material of the filling layer 14, the thickness eᵣ of the pads 13, the width wᵣ of the pads 13 along the longitudinal axis X, the pitch Λᵣ and the filling factor ffᵣ=wᵣ/Λᵣ, defined as the ratio between the width wᵣ and the pitch Λᵣ.

Preferably, the refractive index nᵣ, the thickness eᵣ and the width wᵣ of the pads 13 remain constant over the entire length Lₜₒₜ of the optical antenna 7. Likewise, the notches are still through-notches. The filling factor ffᵣ remains constant here, but it could also exhibit a longitudinal variation. On the other hand, the diffraction grating 8, in the apodized part, exhibits a longitudinal variation Λᵣ(x) in its pitch Λᵣ between an upstream value Λ_{r,in} and a downstream value Λ_{r,out}. The pitch Λᵣ thus varies longitudinally according to a predefined function q, such that Λᵣ=q(x). By way of example, in the case of a Gaussian target profile S_{c}(x), the function q is an increasing monotonic function. The longitudinal variation Λᵣ(i) in the pitch Λᵣ may be denoted in discretized form using an index i varying from 1 to M, where M is the number of periods of the diffraction grating 8 in the apodized part.

The diffraction grating 8 is located at a distance dᵣ from the waveguide 5 so as to have a small impact on the optical mode, and here only its evanescent part, this distance dᵣ being able to be zero or non-zero. It has an extraction rate α, sometimes also called emission strength or scattering strength. As indicated in the Article by Zhao et al. entitled Design principles of apodized grating couplers, Journal of Lightware Technology, vol. 38, no. 16, pp. 4435-4446, 2020, the extracted local optical power, which defines the emission profile S(x), depends on the local power of the optical mode P(x) (here its evanescent part) and on the extraction strength α(x) through the following relationship: S(x)˜α(x)×P(x).

The optical antennas 7 are identical to one another. They all have the same reference structural configuration Cs_{ref}, which is formed by the physical parameters Pp_{wg} of the waveguide 5 (and therefore by the longitudinal variation w_{c}(x)) and by the physical parameters Ppᵣ of the diffraction grating 8 (and therefore by the longitudinal variation Λᵣ(x)). The optical antennas 7 are arranged laterally along the axis Y and parallel to one another. They are spaced from one another by a distance preferably of between λ/2 and 2λ. For information purposes, the number of optical antennas 7 may range from around ten to around ten thousand, so as to limit the divergence of the light radiation in the far field in the plane YZ.

The optical signals circulating in the arms 4 are thus progressively transmitted into free space by diffraction by the optical antennas 7, such that the light radiation emitted by each optical antenna 7 exhibits the target emission profile S_{c}(x) and the target emission angle θ_{c}, which is constant along the longitudinal axis X. The emitted light radiation propagates in free space and recombines by interference, and thus forms, in the far field, the light radiation emitted by the optoelectronic transmitter 1 whose angular distribution about the main emission axis is determined and defines the far-field emission pattern of the optoelectronic transmitter 1.

The optoelectronic transmitter 1 thus emits far-field light radiation that may exhibit relatively little divergence, at least in the plane XZ, and may exhibit a predefined, for example constant or Gaussian, emission pattern. This is therefore achieved by the fact that each optical antenna 7 comprises a diffraction grating 8 located above and at a distance from the waveguide 5, thereby making it possible to reduce the extraction rate ar while impacting only the evanescent part of the optical mode circulating in the waveguide 5, and therefore to increase the transmission length of the optical antenna 7. Moreover, the local value of the extraction rate ar may be adjusted easily by way of the width w_{c} of the waveguide 5, unlike the apodized diffraction gratings from the prior art, in which the authors modify only the dimensions of the periodic structures, as shown for example by the article by Mekis et al. entitled A Grating-Coupler-Enabled CMOS Photonics Platform, IEEE Journal of Selected Topics in Quantum Electronics, vol. 17, no. 3, pp. 597-608, May-June 2011. Finally, longitudinally varying the width W_{c} of the waveguide 5 and at least the pitch Λᵣ of the diffraction grating 8 makes it possible to limit the dimensioning constraints of the periodic structures that could lead to particularly small dimensions (width wᵣ of the pads 13 and/or notches), for example smaller than 100 nm, and which are therefore barely compatible, or not compatible, with the conventional technologies usually used in fabrication processes, for example in photonics-on-silicon.

FIG. 2C is a plan view of an optical antenna 7 of an optoelectronic transmitter

1 according to one variant embodiment. In this example, the diffraction gratings 8 share the same pads 13. In other words, the pads 13 of the diffraction gratings 8 extend continuously facing the waveguides 5 of the optical antennas 7. Moreover, the waveguides 5 exhibit a longitudinal variation w_{c}(x) of a shape different from that illustrated in FIG. 2B.

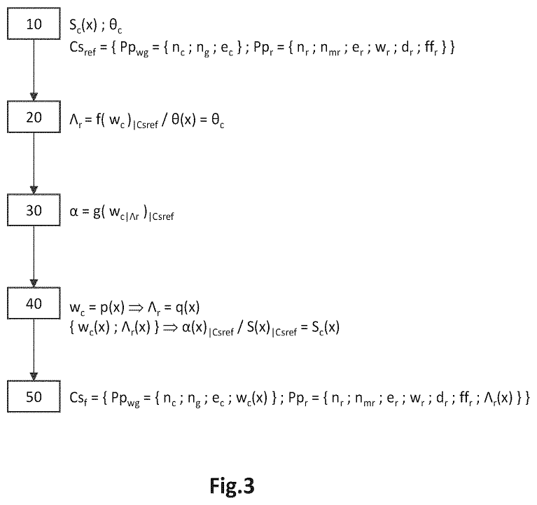

FIG. 3 is a flowchart of a process for fabricating an optoelectronic transmitter 1 according to one embodiment.

In a step 10, the target near-field emission profile S_{c}(x) of the light radiation to be emitted by each optical antenna 7, along with the target emission angle θ_{c}, are defined. By way of example, the emission profile S_{c}(x) is Gaussian. Moreover, the target emission angle θ_{c} is constant for any value x of the longitudinal axis X. It will be considered here that the optical mode has a wavelength λ equal for example to 1550 nm.

Moreover, one and the same reference structural configuration Cs_{ref} is defined for the optical antennas 7. This structural configuration Cs_{ref} comprises the values of the physical parameters Pp_{wg} of the waveguide 5 that define the optical properties of transmission of the optical mode by the waveguide 5, namely the refractive indices n. and n_{g} of the waveguide 5 and of the cladding, and the thickness e_{c} of the waveguide 5, so as to give: Pp_{wg}={n_{c}, n_{g}, θ_{c}}. By way of example, the waveguide 5 may be made of silicon and have a refractive index no of 3.48, and the cladding may be made of SiO₂ and have a refractive index n_{g} of 1.45 at the wavelength λ of 1.55 μm. Moreover, the waveguide 5 here has a constant thickness e_{c} equal to 220 nm. The list of these physical parameters Pp_{wg} will be supplemented by the longitudinal variation w_{c}(x) in the width w_{c} of the waveguide 5, which is determined later.

The structural configuration Csref also comprises the values of the physical parameters Ppᵣ of the diffraction grating 8, which define the optical properties of diffraction of the optical mode by the diffraction grating 8. The physical parameters Ppr may thus comprise the refractive index nᵣ of the pads 13 with a high index, here equal to 2.0 for silicon nitride, the refractive index of the filling material nₘᵣ, here equal to 1.45 for SiO₂, the thickness eᵣ of the pads 13, for example equal to 400 nm, and the spacing dᵣ with the waveguide 5, for example equal to 200 nm. The filling factor ff, here is constant along the longitudinal axis X, and is equal to 0.5 here. Knowing the longitudinal variation Λ(x) in the pitch A later, the filling factor ff makes it possible to determine the width wᵣ of the pads 13. The list of these physical parameters Ppᵣ will be supplemented by the longitudinal variation Λᵣ(x) in the pitch Λᵣ of the diffraction grating 8, which will be determined later.

In a step 20, a relationship Λᵣ=f(w_{c}) is determined that expresses a change in the pitch Λᵣ of the diffraction grating 8 as a function of the width w_{c} of the waveguide 5, taking into account the structural configuration CS_{ref}, such that the local emission angle θ is equal to the target emission angle θ_{c} for all values of x along the longitudinal axis X.

For this purpose, multiple three-dimensional finite-difference time domain (FDTD) simulations of an optical antenna 7 are carried out. In each simulation, the optical antenna 7 has the reference structural configuration Cs_{ref} and a given pair of constant values of width w_{c} and pitch Λᵣ. Therefore, the optical antenna 7 does not exhibit any longitudinal variation in its width we or its pitch Λᵣ(it is not apodized). For each simulation, the value of the emission angle θ of the simulated optical antenna 7 is determined.

This thus gives a relationship between the emission angle θ of the simulated optical antenna 7 as a function for example of the pitch Λᵣ for various values of width w_{c}. Next, for a value of the simulated emission angle θ equal to the target value θ_{c}, the relationship Λᵣ=f(w_{c}) for which the optical antenna 7 emits the light radiation at the target emission angle θ_{c} is obtained.

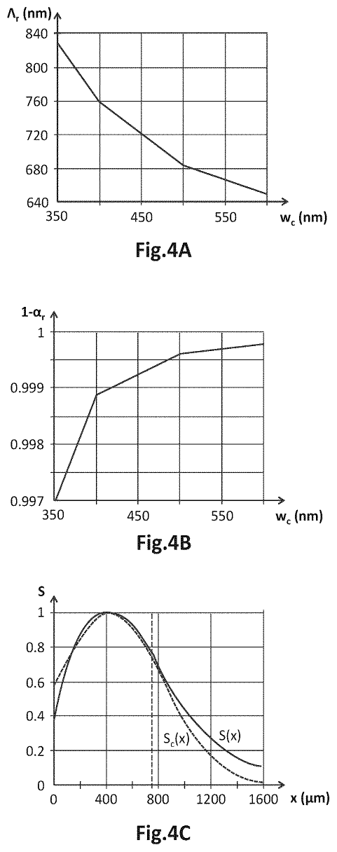

In this respect, FIG. 4A illustrates one example of the change in the pitch Λᵣ of the diffraction grating 8 as a function of the width w_{c} of the waveguide 5, for the reference structural configuration CS_{ref} defined above, and for which the emission angle θ of the simulated optical antenna is equal to a target value θ_{c}, here equal to 8°. The simulations are carried out so as to scan a range of values of the width w_{c}, between a minimum value, here equal to 350 nm, and a maximum value, here equal to 600 nm.

In a step 30, a relationship α=g(w_{c}) is determined that expresses a change in an extraction rate αᵣ of the diffraction grating 8 as a function of the width w_{c} of the waveguide 5, taking into account the reference structural configuration CS_{ref} and the previously determined relationship Λᵣ=f(w_{c}) (therefore for which the emission angle θ(x) is equal to the target value θ_{c}).

For this purpose, multiple three-dimensional finite-difference time domain (FDTD) simulations of an optical antenna 7 are carried out. In each simulation, the optical antenna 7 has the reference structural configuration CS_{f} and a constant value of width w_{c}, and the value of the corresponding pitch Λᵣ is deduced therefrom based on the relationship Λᵣ=f(W_{c}). Therefore, the optical antenna 7 does not exhibit any longitudinal variation in its width w_{c} or its pitch Λᵣ (it is not apodized), and it is known that the corresponding emission angle is equal to the target value θ_{c}. For each simulation, the value of the extraction rate α_{r,sim} of the simulated optical antenna 7, that is to say the ratio of the value of the intensity of the diffracted optical mode to the value of the intensity of the optical mode introduced into the waveguide 5, is determined.

This thus gives the relationship αᵣ=g(w_{c}) between the extraction rate αᵣ of the simulated optical antenna 7 as a function of the width w_{c}, for which the pitch Λᵣ complies with the relationship Λᵣ=f(w_{c}) for which the optical antenna 7 emits the emitted radiation at the target emission angle θ_{c}.

In this respect, FIG. 4B illustrates one example of the change in the extraction rate αᵣ (here 1−αᵣ) of the diffraction grating 8 as a function of the width w_{c} of the waveguide 5, for the reference structural configuration Cs_{ref} defined above, and for which the emission angle θ of the simulated optical antenna is equal to a target value θ_{c} equal to 8°. The simulations are carried out for the range of lengths w_{c} from 350 nm to 600 nm.

In a step 40, a longitudinal variation w_{c}(x) in the width w_{c} of the waveguide 5,

resulting in a longitudinal variation αᵣ(x) in the extraction rate αᵣ for which the emission profile S (x) is equal to the target emission profile S_{c}(x), is determined.

For this purpose, in what is referred to as a theoretical approach, the starting point is that of determining the longitudinal variation α_{r,c}(x) in the target extraction rate α_{r,c} for which the emission profile S(x) is equal to the target emission profile S_{c}x). It is possible to use the same theoretical relationship as or one similar to that described in the abovementioned Zhao 2020 article, namely:

$${α}_{r , c} = \frac{{S}_{c} ( λ )}{2 {\int }_{x}^{∞} {S}_{c} ( x ) dx}$$

Then, knowing the longitudinal variation α_{r,c}(x) in the target extraction rate α_{r,c}, the corresponding longitudinal variation w_{c,c}=p(x) in the width w_{c} of the waveguide 5 is determined based on the previously determined relationship αᵣ=g(w_{c}), and the longitudinal variation Λᵣ=q(x) is determined based on the previously determined relationship Λᵣ=f(w_{c}). However, although this “theoretical” approach may be used in the context of the invention, there is a risk of the obtained longitudinal variation W_{c,c}(x) in the width w_{c} not corresponding entirely to the technological constraints and/or to the values w_{c,in}, w_{c,out} of the width of the waveguide 5 upstream and downstream of the apodized part (for example 350 nm and 600 nm here).

Another advantageous, more “pragmatic” approach may therefore be used. The first step is to define an equation representative of a longitudinal variation w_{c}(x) in the width w_{c} of the waveguide 5 between two predefined upstream and downstream values w_{c,in} and w_{c,out}, respectively. It is desirable for this equation to comprise few parameters to be adjusted (few degrees of freedom) but to cover a wide range of shapes of waveguides 5, so that the corresponding emission profile is equal to the target emission profile S_{c}(x). Preferably, the power function with an exponent n is chosen, expressed here in a continuous form and in a discretized form:

$${w}_{c} ( x ) = {w}_{c , in} - {( \frac{x}{{L}_{a}} )}^{n} \times ( {w}_{c , in} - {w}_{c , out} ) ⇔ {w}_{c} ( i ) = {w}_{c , in} - {( \frac{i}{M} )}^{n} \times ( {w}_{c , in} - {w}_{c , out} )$$

where x is the abscissa, which varies between x₀=0, that is to say the start of the apodized part of the optical antenna 7 where the width is w_{c,in}, and Lₐ, that is to say the end of the apodized part where the width is w_{c,out}, and where i is the number of the period under consideration of the diffraction grating 8, and M is the total number of periods of the apodized part, and where finally n is a free parameter to be determined.

A parametric study is then carried out by varying the parameter n here. In this example, it will be considered that the apodized part of the optical antenna 7 is formed by M=1000 periods, followed by a part of 1000 additional periods where the width W_{c} and the pitch Λᵣ remain constant (width equal to the value w_{c,out}). A number N of FDTD simulations of the optical antenna 7 are carried out, where the parameter n takes a value n₍ₘ₎, where m here is an index varying from 1 to N and associated with the simulation carried out. Thus, for each simulation of index m, a longitudinal variation w_{c(m)}=p(m)(x) in the width W_{c(m)} is obtained based on the above equation in which the parameter n takes a value n₍ₘ₎. The longitudinal variation Λᵣ₍ₘ₎=q₍ₘ₎(x) is also deduced therefrom based on the previously determined relationship Λ=f(w_{c}).

The longitudinal variation αᵣ₍ₘ₎(x) in the extraction rate is then determined based on the relationship αᵣ=g(w_{c}), taking into account the longitudinal variations w_{c(m)}p=p₍ₘ(x) and Λᵣ₍ₘ₎=q₍ₘ₎(x), and the corresponding emission profile S₍ₘ₎(x) is then determined. A similarity parameter is then determined between the emission profile S(m)(x) and the target emission profile S_{c}(x), in other words a difference parameter between these two profiles, for example based on an overlap integral. Finally, the optimum value n₍ₘₒₚₜ₎ of the parameter n, which gives the best value of the similarity parameter, that is to say that minimizes the difference between these two profiles, is chosen. This thus gives the optimum longitudinal variation Wₒ=p₍ₘₒₚₜ₎(x) in the width we of the waveguide 5 along with the corresponding longitudinal variation Λᵣ=q₍ₘₒₚₜ₎(x) in the pitch Λᵣ of the diffraction grating 8, for which the corresponding emission profile S(x) is equal to the target emission profile S_{c}(x) (in the sense of best similarity) with an emission angle θ(x) equal to the target value θ_{c}, which is constant for all values of x. Thus, according to this “pragmatic” approach, it is ensured that the local values of the width w_{c}, associated with the local values of the pitch Λᵣ, effectively comply with the technological constraints and the desired values w_{c,in}, w_{c,out} of the width of the waveguide 5 upstream and downstream of the apodized part.

Finally, in a step 50, the optoelectronic transmitter 1 for which the optical antennas 7 all have the same structural configuration CS_{ref} is fabricated, this therefore being supplemented by the longitudinal variation w_{c}=p(x) in the width w_{c} of the waveguide 5 and by the longitudinal variation Λr=q(x) in the pitch of the diffraction grating 8 that have just been determined.

FIG. 4C illustrates the emission profile S(x) of such an optical antenna 7, along with the target emission profile S_{c}(x). In this example, the optical antenna 7 comprises an apodized part of M=1000 periods (length Lₐ of around 750 μm) followed by a non-apodized part of 1000 additional periods (of a length of 850 μm), with the reference structural configuration indicated above. In the apodized part, the width w_{c} varies between the upstream value W_{c,in} equal to 600 nm and a downstream value w_{c,out} of 350 nm. The filling factor ffᵣ remains equal to 0.5 along the longitudinal axis X, and the parameter n is equal to 0.3. In addition, the target emission angle is equal to 8° here.

In the apodized upstream part, ranging here from x=0 to x=Lₐ=around 750 nm, the emission profile S(x) is Gaussian and exhibits good similarity with the target Gaussian profile S_{c}(x). In the non-apodized downstream part, the emission profile exhibits an exponential decrease, which also corresponds here to the target profile. A dashed vertical line is used to represent the transition, in the optical antenna 7, between the apodized part and the non-apodized part.

The fabrication process thus makes it possible to produce an optoelectronic transmitter 1 each optical antenna 7 of which, by virtue of the longitudinal variations in the width w_{c} of the waveguide 5 and in the pitch Λᵣ of the diffraction grating 8 over at least part of the length of the optical antenna 7, emits light radiation having the desired near-field emission profile and emission angle. The far-field emission pattern thus corresponds to the desired pattern, and exhibits little divergence, at least in the plane XZ. Moreover, it is not necessary to produce a diffraction grating having dimensions that not compatible or are barely compatible with the constraints of the usual photonic platform fabrication processes.

Some particular embodiments have just been described. Various variants and modifications will be apparent to those skilled in the art.

The fabrication process may thus also comprise a phase of adjusting the filling factor ff, or even of determining a longitudinal variation ff(x), a phase of adjusting the length of the apodization part, or other physical parameters. As indicated above, the emission profile may be of different types, for example Gaussian or constant. Moreover, the diffraction grating 8 may comprise, as here, pads 13 with a high index, or even, inter alia, may be formed by notches made in the surface of the cladding layer.

1. A process for fabricating an optical phased array transmitter including a splitter coupled to a laser source; a plurality of waveguides, coupled to the splitter and extending along a longitudinal axis in a main plane, forming arms of the optoelectronic transmitter a plurality of phase shifters and optical antennas, arranged in the arms, each optical antenna being formed by the corresponding waveguide and by a diffraction grating located above and at a distance from the waveguide along a vertical axis orthogonal to the main plane, the process comprising:
defining a target near-field emission profile and a target emission angle for light radiation emitted by each optical antenna, and a structural configuration of said optical antennas, comprising: values of physical parameters of the waveguides defining optical properties of transmission of an optical mode from the laser source, and values of physical parameters of the diffraction gratings defining optical properties of diffraction of the optical mode;
determining a first relationship expressing a change in a pitch of periodic structures of the diffraction grating as a function of a width of the waveguide, such that, taking into account said structural configuration an emission angle of the light radiation emitted by the optical antenna is equal to said target emission angle;
determining a second relationship expressing a change in an extraction rate of the diffraction grating as a function of the width of the waveguide, taking into account said first relationship and said structural configuration;
determining a longitudinal variation w_{c}(x) in the width of the waveguide and deducing a corresponding longitudinal variation in the pitch of the diffraction grating based on said first relationship, such that, taking into account said relationship and said structural configuration field emission profile of the light radiation emitted by the optical antenna is equal to said target emission profile; and
fabricating the optoelectronic transmitter whose optical antennas have the reference structural configuration, supplemented by said longitudinal variation in the width of the waveguide and said longitudinal variation in the pitch of the diffraction grating.

2. The fabrication process as claimed in claim 1, wherein the steps of determining the first and second relationships are carried out for a range of widths ranging from a predefined minimum value w_{c,out} and a predefined maximum value.

3. The fabrication process as claimed in claim 2, wherein the step of determining the longitudinal variation comprises:
defining a power function with an exponent n representative of a longitudinal variation in the width between the predefined maximum value and the predefined minimum value;
determining, for multiple values of the exponent, a longitudinal variation in the width of the waveguide and deducing a corresponding longitudinal variation in the pitch of the diffraction grating; and
determining a longitudinal variation in the corresponding extraction rate based on said second relationship, and then a corresponding emission profile, and
determining an optimum value from among the values of the exponent for which the emission profile exhibits a minimum deviation from the target emission profile.

4. The fabrication process as claimed in claim 3, wherein the power function is w_{c}(x)=w_{c,in}+(x/Lₐ)ⁿ×(w_{c,in}−w_{c,out}), where Lₐ is a total length of the part of the optical antenna that exhibits the longitudinal variations in the width of the waveguide and the pitch of the diffraction grating.

5. An optical phased array transmitter, comprising:
a splitter coupled to a laser source;
a plurality of waveguides, coupled to the splitter and extending along a longitudinal axis in a main plane, forming arms of the optoelectronic transmitter;
a plurality of phase shifters and optical antennas arranged in the arms, each optical antenna being formed by the corresponding waveguide and by a diffraction grating located above and at a distance from the waveguide along a vertical axis orthogonal to the main plane,
wherein, over at least part of the length of each optical antenna:
the waveguide has a width that varies longitudinally according to a first predefined function; and
the diffraction grating has an arrangement pitch of periodic structures that varies longitudinally according to a second predefined function;
the first and second predefined functions being predefined such that a near-field emission profile of the light radiation emitted by the optical antenna is equal to a predefined target emission profile, and that a local emission angle of the emitted light radiation is equal to a predefined, longitudinally constant target emission angle.

6. The optoelectronic transmitter as claimed in claim 5, wherein the first function regarding longitudinal variation in the width is a decreasing function, and the second function regarding longitudinal variation in the pitch is an increasing function.

7. The optoelectronic transmitter as claimed in claim 5, wherein each of the periodic structures extends facing all of the waveguides of the optical antennas.

8. The optoelectronic transmitter as claimed in claim 5, wherein the waveguides and the diffraction gratings are produced in a silicon-based photonic chip.

9. The optoelectronic transmitter as claimed in claim 5, wherein the periodic structures of the diffraction gratings have a vertical dimension, along the vertical axis, that is constant along the longitudinal axis of the optical antennas.

10. The optoelectronic transmitter as claimed in claim 5, wherein the periodic structures of the diffraction gratings have a filling factor, defined as a ratio between a transverse dimension of the periodic structures along the longitudinal axis and the pitch, that is constant along the longitudinal axis of the optical antennas.
